(19) United States
(12) Patent Application Publication
(10) Pub. No.: US 2025/0244951 A1
(43) Pub. Date: Jul. 31, 2025

(54) FLOATING POINT ACCUMULATION

(71) Applicant: Arm Limited, Cambridge (GB)

(72) Inventors: Mairin Imro KROES, Letchworth Garden City (GB); Anisha SAINI, Austin, TX (US); Thomas ELMER, Austin, TX (US); Neil BURGESS, Cardiff (GB)

(21) Appl. No.: 18/428,446

(22) Filed: Jan. 31, 2024

(51) Int. Cl. G06F 7/499

(52) U.S. Cl. CPC G06F 7/49915

(57) ABSTRACT

There is provided an apparatus, a system, a chip containing product, a method and a medium, the apparatus comprises decoder circuitry responsive to a floating point accumulate instruction identifying pairs of floating point operands and an accumulation source, and processing circuitry comprising a plurality of arithmetic combination units to perform an arithmetic operation to combine the pairs of operands, and summation circuitry to perform an arithmetically precise summation operation to calculate an intermediate result by summing results generated by the arithmetic combination units. The intermediate result is independent of an order in which the arithmetic results are summed. The processing circuitry comprises accumulation circuitry to accumulate the intermediate result into the accumulation source and rounding circuitry to perform a rounding operation after accumulating, and is configured to propagate additional precision information relating to the arithmetic results, the intermediate result, and/or the prior accumulation value to the rounding circuitry.

### CROSS REFERENCE(S) TO RELATED APPLICATION(S)

The entire subject matter of commonly-assigned U.S. application Ser. No. 18/428,137, filed on Jan. 31, 2024, entitled “SIGNIFICAND SHIFTING IN FLOATING POINT OPERATIONS” is incorporated herein by reference.

### TECHNICAL FIELD

The present invention relates to data processing. Furthermore, the present invention relates to an apparatus, a system, a chip containing product, a method, and a non-transitory computer-readable medium.

### BACKGROUND

Some apparatuses are provided with processing circuitry for performing arithmetic operations using floating point operands. Providing circuitry for accumulation of results of the floating point operands can require circuits having large circuit area and/or power consumption.

### SUMMARY

According to a first aspect of the present techniques there is provided an apparatus comprising:
decoder circuitry responsive to a floating point accumulate instruction identifying a plurality of pairs of floating point operands and an accumulation source, to generate control signals to trigger a floating point accumulation operation; and
processing circuitry responsive to the control signals, to perform the floating point accumulation operation, the processing circuitry comprising:
a plurality of arithmetic combination units configured, for each pair of operands of the plurality of pairs of floating point operands, to perform an arithmetic operation to combine that pair of operands;
   summation circuitry configured to receive arithmetic results generated by each of the plurality of arithmetic combination units and to perform an arithmetically precise summation operation to calculate an intermediate result by summing the arithmetic results, wherein the intermediate result is independent of an order in which the arithmetic results are summed;
   accumulation circuitry configured to retrieve a prior accumulation value from the accumulation source and to accumulate the intermediate result into the accumulation source; and
   rounding circuitry configured to perform a rounding operation after accumulating the intermediate result into the accumulation source,
wherein the processing circuitry is configured to propagate additional precision information to the rounding circuitry, the additional precision information relating to at least one of the arithmetic results, the intermediate result, or the prior accumulation value.

According to a second aspect of the present techniques there is provided a system comprising:
the apparatus of the first aspect, implemented in at least one packaged chip;
at least one system component; and
a board,
wherein the at least one packaged chip and the at least one system component are assembled on the board.

According to a third aspect of the present techniques there is provided a chip-containing product comprising the system of the second aspect assembled on a further board with at least one other product component.

According to a fourth aspect of the present techniques there is provided a method comprising:
with decoder circuitry and in response to a floating point accumulate instruction identifying a plurality of pairs of floating point operands and an accumulation source generating control signals to trigger a floating point accumulation operation; and
with processing circuitry and in response to the control signals, performing the floating point accumulation operation, comprising:
   for each pair of operands of the plurality of pairs of floating point operands, performing an arithmetic operation to combine that pair of operands;
   receiving arithmetic results generated by each of the plurality of arithmetic combination units and performing an arithmetically precise summation operation to calculate an intermediate result by summing the arithmetic results;
   retrieving a prior accumulation value from the accumulation source and accumulating the intermediate result into the accumulation source; and
   performing a rounding operation after accumulating the intermediate result into the accumulation source; and
   with the processing circuitry propagating additional precision information to the rounding operation, the additional precision information relating to at least one of the arithmetic results, the intermediate result, or the prior accumulation value.

According to a fifth aspect of the present techniques there is provided a non-transitory computer-readable medium to store computer-readable code for fabrication of an apparatus comprising:
decoder circuitry responsive to a floating point accumulate instruction identifying a plurality of pairs of floating point operands and an accumulation source, to generate control signals to trigger a floating point accumulation operation; and
processing circuitry responsive to the control signals, to perform the floating point accumulation operation, the processing circuitry comprising:
a plurality of arithmetic combination units configured, for each pair of operands of the plurality of pairs of floating point operands, to perform an arithmetic operation to combine that pair of operands;
   summation circuitry configured to receive arithmetic results generated by each of the plurality of arithmetic combination units and to perform an arithmetically precise summation operation to calculate an intermediate result by summing the arithmetic results, wherein the intermediate result is independent of an order in which the arithmetic results are summed;
   accumulation circuitry configured to retrieve a prior accumulation value from the accumulation source and to accumulate the intermediate result into the accumulation source; and
   rounding circuitry configured to perform a rounding operation after accumulating the intermediate result into the accumulation source,
wherein the processing circuitry is configured to propagate additional precision information to the rounding circuitry, the additional precision information relating to at least one of the arithmetic results, the intermediate result, or the prior accumulation value.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates an apparatus according to some configurations of the present techniques;

FIG. 4 schematically illustrates alignment of an accumulation value with a sum of products according to some configurations of the present techniques;

FIG. 5 schematically illustrates alignment of an accumulation value with a sum of products according to some configurations of the present techniques;

FIG. 6 schematically illustrates alignment of an accumulation value with a sum of products according to some configurations of the present techniques;

FIG. 7 schematically illustrates alignment of an accumulation value with a sum of products according to some configurations of the present techniques;

FIG. 8 schematically illustrates a floating point format according to some configurations of the present techniques;

FIG. 9 schematically illustrates an apparatus according to some configurations of the present techniques;

FIG. 10 schematically illustrates an apparatus according to some configurations of the present techniques;

FIG. 11a schematically illustrates a shift according to some configurations of the present techniques;

FIG. 11b schematically illustrates a shift according to some configurations of the present techniques;

FIG. 12 schematically illustrates an apparatus according to some configurations of the present techniques;

FIG. 13 schematically illustrates an apparatus according to some configurations of the present techniques;

FIG. 14 schematically illustrates an apparatus according to some configurations of the present techniques;

FIG. 15 schematically illustrates a sequence of steps according to some configurations of the present techniques; and

FIG. 16 schematically illustrates a system and a chip containing product according to some configurations of the present techniques.

### DESCRIPTION OF EXAMPLE CONFIGURATIONS

Before discussing the configurations with reference to the accompanying figures, the following description of configurations is provided.

Hardware machine learning (ML) acceleration is particularly important to contemporary “Artificial Intelligence” (AI) research and commercialization, facilitating very large neural network models, e.g., Deep Neural Networks (DNNs) in a variety of useful inference applications. This commercial market is currently experiencing explosive growth. The goal of such hardware acceleration is to provide feasible computation of fused floating-point multiply-accumulates (FMAs) that may number 10⁸-10¹¹ individual calculations.

Feasibility for these computing systems can be thought of in terms of wall-clock latency, total energy consumption, and system cost. Consequently, the rate of calculation (throughput), and efficiency of silicon solutions (measured, for example, in terms of silicon area and/or power consumption) are important factors. Numerical accuracy is an additional design goal. Floating point data formats provide adaptable ranges of calculation which is a desirable characteristic. Fused floating-point multiply-accumulate with single rounding is inherently more numerically accurate than disjoint floating point multiply and add.

FMA hardware processes a variety of data types in varying bit widths including 16, 32, 64, and 128 bits. Such hardware provides the summation of a single unrounded product with a single accumulator, after which a single numeric rounding operation is completed. This is in contrast to disjoint multiply and add which require two separate rounding operations, leading to reduced numerical accuracy.

Considering that neural network models require very long strings of accumulator dependent multiply-accumulate, numerical inaccuracy can be introduced by the long sequential chains of individual rounding operations that follow each FMA. For example, if a very small product value is added to a very large accumulator value the resulting rounded sum may evidence no influence from the small product value.

These serial computations are also disadvantageous with regard to throughput. Parallel computations provide an immediate improvement to throughput, but do not address the described detriment to numerical accuracy. Additionally, contemporary research and commercial application have demonstrated that data formats requiring 16 bits or larger are excessive for these applications. Floating point and quantized integer data in 8-bit formats has been used successfully for large portions of the required calculations for various neural networks. These 8-bit data formats immediately economize memory storage, memory bandwidth, and energy to transmit each piece of data. Additionally, calculations on 8-bit data formats usually can be much more economical than larger data types with regard to silicon area, circuit power consumption, and/or circuit complexity.

In accordance with one example configuration there is provided an apparatus comprising: decoder circuitry responsive to a floating point accumulate instruction identifying a plurality of pairs of floating point operands and an accumulation source, to generate control signals to trigger a floating point accumulation operation. The apparatus is provided with processing circuitry responsive to the control signals, to perform the floating point accumulation operation. The processing circuitry comprises a plurality of arithmetic combination units configured, for each pair of operands of the plurality of pairs of floating point operands, to perform an arithmetic operation to combine that pair of operands. The processing circuitry is also provided with summation circuitry configured to receive arithmetic results generated by each of the plurality of arithmetic combination units and to perform an arithmetically precise summation operation to calculate an intermediate result by summing the arithmetic results. The intermediate result is independent of an order in which the arithmetic results are summed. The processing circuitry is also provided with accumulation circuitry configured to retrieve a prior accumulation value from the accumulation source and to accumulate the intermediate result into the accumulation source. The processing circuitry is also provided with rounding circuitry configured to perform a rounding operation after accumulating the intermediate result into the accumulation source. The processing circuitry is configured to propagate additional precision information to the rounding circuitry, the additional precision information relating to at least one of the arithmetic results, the intermediate result, or the prior accumulation value.

The decoder circuitry is responsive to instructions that form part of an instruction set architecture (ISA). The ISA is a complete set of instructions that can be used by a programmer or compiler to specify how the apparatus should operate. The floating point accumulate instruction is one of the instructions of the ISA and is recognised by the decoder circuitry. The control signals generated by the decoder circuitry provide information to the processing circuitry to cause the processing circuitry to perform the floating point accumulation operation. The floating point accumulate instruction identifies a plurality of pairs of floating point operands, i.e., it identifies two or more sets of two floating point operands. The pairs of floating point operands may be identified as individual values in specific floating point scalar registers or as operands stored in corresponding positions in two or more vector floating point registers.

The floating point accumulation operation comprises steps of arithmetically combining the pairs of operands specified by the floating point accumulation operation to generate plural (i.e., two or more) arithmetic results. The arithmetic results are then passed to summation circuitry which sums the plural arithmetic results using arithmetically precise summation circuitry. The term “arithmetically precise” as used herein indicates that there is no loss of precision in performing that summation operation, i.e., the result of the summation is identical to a result that would be obtained if the processing circuitry had infinite storage/infinite precision. The arithmetically precise result is independent of an order in which the arithmetic results are received. In other words, the result of the arithmetically precise summation is arithmetically the same as if the results were received simultaneously (e.g., in a same instruction cycle/clock cycle). As discussed, due to the numerical imprecision of some floating point circuits, the result of a summation of three operands in such circuits may vary dependent on the order and size of those operands. As a simple example, the sum A+B+C where B is much less than A and C is equal to minus A would mathematically be equal to B. However, if A is first added to B, and B is sufficiently small that it does not influence the result, then A+B may be approximated as being equal to A. Then, once C is added, the result would be zero. Such a summation is not numerically precise and is dependent on the order in which the operands are summed. A numerically precise summation for which the result is independent of an order in which the operands are received, can be performed by retaining additional precision information in the summation of A+B such that when C is added, it can be recognised that the result of A+B+C is non-zero, i.e., it is equal to B.

The intermediate result, generated by the arithmetically precise summation circuitry, can be considered as an arithmetically precise intermediate value that is independent of the order in which the pairs of operands are specified in the floating point accumulate instruction. The floating point accumulation instruction also identifies an accumulation source, which in some configurations is a floating point accumulation source. The intermediate result is accumulated with the existing accumulator value before being rounded using a single rounding operation. In some configurations the single rounding operation is the only rounding operation carried out by the processing circuitry in response to the floating point accumulate instruction. The single rounding operation may comprise more than one numerical calculation. For example, the single rounding operation may be a compound operation comprising plural rounding stages, e.g., a stochastic rounding step to reduce precision followed by a conventional Round To Nearest Even step with no intervening summation of additional addends. In other words, all the rounding is carried out at a single stage of the operation, e.g., after the accumulation. In other words, the floating point accumulation operation consists of a single rounding operation and the results generated by the summation circuitry and the arithmetic combination units are propagated without being rounded. Throughout the operation the processing circuitry may propagate additional precision information to ensure that the resulting accumulated value retains full numerical precision. The additional precision information may relate to one or more of the arithmetic results, the intermediate result, and/or the prior accumulation value.

Compared to a circuit using multiple floating point FMAs in which each FMA provides only the summation of a single product with a single accumulator, the present techniques mitigate the detriments of serial processing delay and sequential accrual of rounding error. The approach described herein provides improved accuracy and offers a fully associative circuit for floating point accumulate instructions. In addition, the circuit design leads to the parallelization of the arithmetic operations, and allows several rounding operations to be removed and replaced with numerically accurate arithmetic.

According to the present techniques, plural sequential FMA operations (each with a rounding step) are replaced by a single microinstruction (the floating point accumulate instruction) providing multi-way multiply accumulate with a single rounding operation. As discussed, the single rounding operation need not be limited to a single calculation and may comprise, for example, a stochastic step followed by a standard rounding step, e.g., a Round To Nearest Even step. The benefit of this approach becomes even more significant for reduced precision, 8-bit floating point data. This additional accuracy is highly beneficial to the use of reduced precision formats where the potential effect of calculation error may become more significant. Overall, the circuits and techniques described herein provide combined advantages that are particularly valuable to contemporary system designs for hardware ML acceleration.

In some configurations the processing circuitry is configured to defer rounding of results of the arithmetic operation for each pair of operands until the rounding operation, and to defer rounding of results of the arithmetically precise summation operation until the rounding operation. In other words, the processing circuitry does not perform any steps of rounding until the rounding operation and retains, as the additional precision information, all numerical data that will influence the numerical result of the rounding.

In some configurations the processing circuitry is configured to support at least one floating point format specifying at least a significand portion having a significand bit width and an exponent portion having an exponent bit width; and the additional precision information comprises additional significand information extending a bit width of at least one of the arithmetic results by at least one additional bit relative to a bit width of the significand portion of the plurality of pairs of floating point operands. One advantage of using a floating point format is that a large range of values can be represented to a same level of precision. This is achieved by recording the values as having a significand portion and an exponent portion. The exponent portion identifies the scale of the floating point number defining the magnitude of the number represented by the significand portion. The processing circuitry may support one or plural floating point formats. Each floating point format may require a different number of bits and/or be represented using normal representation (where the significand portion comprises an implicit 1 as a most significant bit) or sub-normal representation (where the significand portion comprises an implicit 0 as a most significant bit). The arithmetic combination of two operands represented using the at least one floating point format may require additional bit width to represent the result of the arithmetic combination operation. For example, the multiplication of two 8-bit binary numbers may require up to 16 bits to fully represent the result. Similarly, the addition of two 8-bit binary numbers may require up to 9 bits to fully represent the result. This additional precision information may, dependent on the values of the operands involved, influence the result of the numerically precise summation and is therefore propagated as the additional precision information throughout the circuit.

In some configurations the bit width of the significand portion of each of the arithmetic results is greater than or equal to a sum of the bit width of the significand portions of each of the pair of operands from which that arithmetic result is generated. The bit width of the significand portions for each of the pair of operands may be the same, for example, if each of the pair of operands are represented using a same floating point representation format. However, this need not be the case and each of the operands may be represented using a different floating point format. The additional precision information that is used to represent the result of the arithmetic combination of the pairs of operands is therefore dependent on the format of each of the floating point operands.

In some configurations the processing circuitry comprises alignment circuitry to perform at least one alignment operation to align the arithmetic results to a common magnitude prior to the arithmetically precise summation operation. Dependent on the values of the exponent portions of the pairs of operands specified in the floating point accumulate instruction, the arithmetic results may vary significantly in magnitude. For example, one of the arithmetic results may be larger or smaller than another by several orders of magnitude. By aligning the arithmetic results to the common magnitude, the summation circuitry is able to perform the arithmetically precise summation retaining the necessary information for generating the intermediate value by summing arithmetic results that overlap in magnitude when aligned and retaining additional precision information from arithmetic results that do not overlap with other arithmetic results.

In some configurations, the common magnitude is determined based on at least one of: a magnitude of a largest exponent of the arithmetic results; and a summation of a maximum calculable arithmetic exponent and a characteristic multiplicity factor determined as a ceiling value of a base-2 logarithm of a multiplicity of the plurality of pairs of floating point operands. The multiplicity of the plurality of pairs of floating point operands is equal to the number of pairs of floating point operands, i.e., the number of arithmetic results. In some configurations, the common magnitude (otherwise referred to as a predetermined common magnitude or, in some configurations, a common exponent) is equal to a summation of a maximum calculable arithmetic exponent plus one and a characteristic multiplicity factor determined as a ceiling value of a base-2 logarithm of a multiplicity of the plurality of pairs of floating point operands. The maximum calculable arithmetic exponent is determined based on the floating point formats supported by the processing circuitry. As a result, using a common magnitude based on the maximum calculable exponent and the multiplicity factor results in a common magnitude that is independent of the values of the floating point operands. This approach avoids the need to perform a large number of comparison operations between the arithmetic results to determine the relative sizes of the exponents when performing the alignment. Rather, the only comparisons required are between the arithmetic results and the predetermined common magnitude.

In some configurations, the alignment of arithmetic results relative to the predetermined common magnitude may accept a predetermined scaling factor causing the individual arithmetic results to be shifted by more, or less, than the described difference from the predetermined common magnitude, and affecting the alignment of each of the arithmetic results by an equal amount. In some configurations the floating point accumulate instruction further specifies the predetermined scaling factor and the alignment with respect to the predetermined common magnitude is performed subsequent to modification of the predetermined common magnitude through the addition or subtraction of the predetermined scaling factor. It would be readily apparent to the person of ordinary skill in the art that, where the alignment is provided by shifting by a shift amount, the predetermined scaling factor could be added to/subtracted from the predetermined common magnitude prior to the shifting or, in alternative configurations, a second shift could be performed based on the scaling factor. The use of such a predetermined scaling factor may for example by be useful when using a floating point format (such as FP8) with a relatively limited dynamic range of representation.

The processing circuitry may propagate the additional precision information in any way. However, in some configurations the summation circuitry is configured to output the intermediate result having an intermediate result bit width extended to comprise: a most significant portion comprising sufficient bit width to store the significand portion of the prior accumulation value; and a least significant portion having a bit width sufficient to store the intermediate result. In general, the relative magnitudes of the prior accumulation value and the intermediate result will either be comparable such that there is some overlap of bits representing the prior accumulation value and the intermediate value, or there will be sufficient magnitude difference between the prior accumulation value and the intermediate result that there is no overlap of bits representing these values. The placement of the bits representing the value of the intermediate result need not be placed in the least significant portion but may be positioned dependent on the magnitude of the value of the intermediate result relative to the common magnitude. Provision of the intermediate result having the intermediate result bit width allows the processing circuitry to align the results relative to the common magnitude such that it can be accumulated with the prior accumulation value without loss of precision.

In some configurations the accumulation circuitry comprises accumulator alignment circuitry to perform an accumulator alignment operation to align the significand portion of the prior accumulation value to the common magnitude based on a magnitude stored in the exponent portion of the prior accumulation value and the common magnitude. Aligning the prior accumulation value to the common magnitude simplifies the accumulation process as the accumulator does not need to be aligned based on a magnitude of the intermediate result.

In some configurations, when the magnitude stored in the exponent portion of the prior accumulation value exceeds the common magnitude by an amount greater than a bit width of the most significant portion, the accumulator alignment operation comprises aligning the significand portion of the prior accumulation value to the most significant portion. Aligning the accumulation value in this way results in the magnitude of the aligned accumulator significand exceeding the magnitude of the intermediate result. The intermediate result therefore only affects the rounding of the accumulation at the rounding stage.

The alignment can be achieved using any alignment method. For example, the alignment of the accumulator could be achieved using left shift circuitry and right shift circuitry with the shifting circuitry (left or right) being selected based on a direction of the shift. In some configurations the accumulator alignment circuitry is configured: to shift the significand portion of the prior accumulation value by a shift amount equal to a difference between the magnitude of the exponent portion of the prior accumulation value and the common magnitude; when the shift amount indicates a shift in a first direction, to shift the significand of the prior accumulation value in the first direction by the shift amount; and when the shift amount indicates a shift in a second direction opposite to the first direction, to shift the significand portion of the prior accumulation value in the first direction by an amount equal to a difference between a predetermined correction amount and the shift amount and to shift the significand portion of the prior accumulation value by the predetermined correction amount in the second direction. Dependent on the implementation, the first shift direction may correspond to one of a right shift or a left shift with the second shift direction corresponding to the other of the right shift and the left shift. The alignment circuitry is optimally able to shift in the second direction by the predetermined correction amount. This approach simplifies the alignment circuitry by eliminating the need to provide shifting circuitry that can shift by any amount in the second direction. The predetermined correction amount may correspond to a maximum possible shift in the second direction. The amount by which the shift circuitry is able to shift in each direction need not be symmetric. In some configurations, the maximum shift in the first direction may be greater than the maximum shift in the second direction or may be smaller than the maximum shift in the second direction. In some configurations, the predetermined correction may be one of plural possible predetermined corrections resulting in a coarse grained shifting in the second direction and a fine grained shift in the first direction. In some configurations, the shift amount may be represented using a twos complement representation in which the most significant bit of the twos complement representation indicates a requirement to shift by the predetermined correction amount in the second direction and the remaining bits of the twos complement representation indicate a requirement to shift by the defined amount in the first direction.

In some configurations the accumulation circuitry is configured to output an unrounded result obtained by accumulating the intermediate result into the accumulation source; and the apparatus comprises normalising circuitry configured, prior to the rounding operation, to normalise the unrounded result. The normalisation comprises manipulation of the unrounded result to a floating point format supported by the processing circuitry. The normalisation may include alignment of the unrounded value and or formatting the unrounded value in normal or sub-normal format. The normalisation may include a step of identifying a sign of the unrounded result and, when the unrounded result is a negative value, converting the unrounded result to a positive value and storing an indication of the negative value in a sign bit of the floating point format.

The floating point accumulation operation may be provided as a circuit capable of performing the operation in a single cycle. In some configurations the floating point accumulation operation is a multi-cycle operation performed over a plurality of instruction cycles; the arithmetic operation for each pair of operands is performed in a different instruction cycle to the arithmetically precise summation operation; the at least one alignment operation comprises a first alignment operation performed in a same clock cycle as the arithmetic operation and a second alignment operation performed in a same clock cycle as the arithmetically precise summation operation; and a bit width of an output of the first alignment operation is less than a bit width of the output of the second alignment operation. Performing the full alignment operation in a same cycle as the arithmetic operation would require a greater amount of information to be propagated to the next cycle. Alternatively, performing the full alignment operation in the same cycle as the arithmetically precise summation operation increases the processing burden in that clock cycle potentially increasing power consumption and/or required circuit area. Splitting the alignment operation in this manner simplifies the alignment that is required in each cycle and reduces the total amount of data that needs to be transferred between cycles resulting an overall improvement in processing efficiency.

In some configurations the accumulator alignment operation is performed in a same clock cycle as accumulating the intermediate result into the accumulation source. Performing the accumulator alignment operation in a same clock cycle as the accumulation reduces the amount of information that needs to be propagated between different clock cycles. In alternative configurations the accumulator alignment operation is performed in a clock cycle prior to accumulating the intermediate result into the accumulation source.

In some configurations the floating point accumulate instruction is a floating point dot product instruction, and the floating point accumulation operation is a dot product with accumulation operation. The arithmetic operation in the dot product with accumulation operation is a multiplication operation. Floating point dot product operations are common in machine learning applications. Hence, the provision of the current techniques to a floating point dot product with accumulation may be of particular use in such applications.

In some configurations the plurality of arithmetic combination units comprises N arithmetic combination units; the decoder circuitry is responsive to at least two types of floating point dot product instruction including an N-product floating point dot product instruction specifying N pairs of floating point operands, and an M-product floating point dot product instruction specifying M pairs of floating point operands, wherein M is less than N; and the processing circuitry is responsive to the control signals generated in response to at least one encoding of the M-product floating point dot product instruction to perform two dot product with accumulation operations in parallel, at least one of the two dot product with accumulation operations reusing at least some of the N arithmetic combination units. In some configurations both of the two dot product with accumulation operations may reuse at least some of the N arithmetic combination units. Reusing one or more of the N arithmetic combination units for one or more of the two dot product operations reduces the total amount of circuitry required when providing processing circuitry capable of performing such operations in parallel and provides additional implementation flexibility.

In some configurations the plurality of arithmetic combination units are configured to represent the plurality of arithmetic results using a twos complement representation. The arithmetic combination units therefore combine the pairs of operands and modify a representation of the results to use the twos complement representation. Providing the arithmetic results using the twos complement representation allows the summation circuitry to perform the arithmetically precise summation taking into account a sign of the results directly and removes additional steps required to negate the arithmetic results. In some configurations the twos complement representation may be used by the processing circuitry until a normalisation step after the accumulation.

In some configurations processing circuitry is configured to convert a binary representation of at least one floating point operand and/or a binary representation of at least one of the arithmetic results from a first binary representation into a second binary representation whilst performing the floating point accumulation operation. Changing a binary representation of the values at different stages in the processing circuitry allows the different blocks of the processing circuitry to take advantage of different formatting which may be beneficial for performing the different steps of the processing.

In some configurations the arithmetic operation comprises at least one of: a multiplication operation; and a division operation. It would be readily apparent to the skilled person that the arithmetic operation could be any arithmetic operation dependent on the particular use case.

In some configurations the processing circuitry is configured to store at least one intermediate result of the floating point accumulation operation in a redundant binary format. The redundant binary format may be, for example, a carry sum format output from a carry-save adder. For example, the summation circuitry may be provided using one or more carry-save adder circuits with the accumulation being provided with a carry-propagate adder to output the unrounded result in a non-redundant binary format.

In some configurations the arithmetic combination units comprise a set of multiplication units, for example, using an 8-bit floating point (FP8) format or a 32-bit floating point format. The multiplication units may be capable of handling a range of different operands including E4M2 (4 exponent bits and 2 mantissa bits from which the significand is defined) and E5M2 (5 exponent bits and 2 mantissa bits) FP8 values. The multiplication units perform signed multiplication of a pair of sign-magnitude floating point significands and efficiently convert the result to a twos complement result in the process. The multiplication units first perform the floating point significand multiplication. In binary multiplication, the partial products may be produced by multiplying the multiplicand with each bit in the multiplier. Each partial product is therefore produced by multiplying the multiplicand by a power of two which can be achieved using a shift operation. The partial products are then, subsequently, added together. One way of achieving this is through the use of carry-save adders which output the result in a redundant binary format, the carry-sum format. The results of the carry-save adders are then brought together using a final carry propagate adder. A carry propagate adder introduces additional delay over in comparison to the carry save adder. Hence, it is desirable to minimise the number of carry propagate adders that are used. Where the input pair of values are each represented as a sign magnitude value the sign may be dealt with during this final stage of addition. By calculating the logical XOR (exclusive-OR) of the sign bits, it can be determined if a negation is required. Where the sign bits associated with the two floating point significands are the same (either both positive or both negative), then the result is positive and no negation is required (the output of the XOR gate is 0). When the sign bits associated with the two floating point significands are different (one negative and one positive), then negation is required (the output of the XOR gate is 1). Negation can, in some configurations, be performed through the use of an additional negation step subsequent to the carry-propagate adder. For a twos complement representation, negation is carried out by inverting the bits and adding one. This step necessitates a further addition step which may be carried out using a further carry propagate adder. In alternative configurations, the negation may be carried out before the final carry propagate adder whilst the arithmetic result is still in the redundant carry-sum format. Performing the negation at this stage requires that the bits of both the carry portion and the sum portion are inverted and that a value of one is added to each of the carry portion and the sum portion. Advantageously, the addition can be performed using a carry-save adder in each case. In some configurations, rather than adding a value of one to each of the carry portion and the sum portion, a value of two could be added to one of the carry portion and the sum portion. Performing the negation before the carry propagate adder eliminates the need for a second carry-propagate stage reducing the overall circuit complexity and, hence, reducing circuit area. Furthermore, the removal of a second carry-propagate stage reduces the delay associated with negating the arithmetic result.

Particular configurations will now be described with reference to the figures.

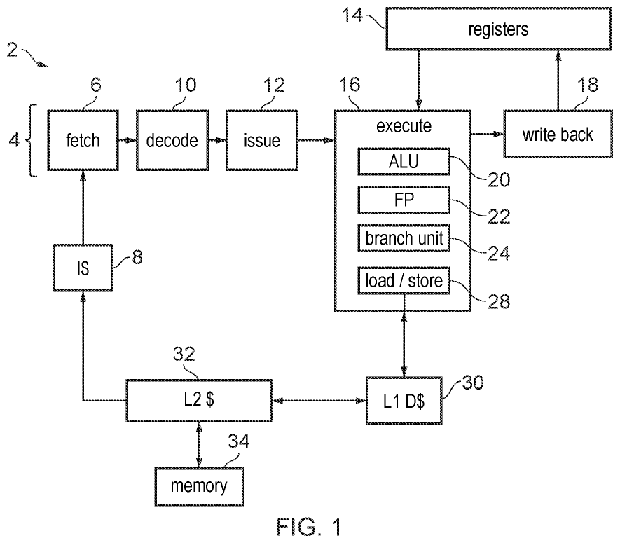

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetch program instructions to generate micro-operations to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example, in an out-of-order processor an additional register renaming stage could be included for mapping architectural registers specified by program instructions or micro-operations to physical register specifiers identifying physical registers in the register file 14.

The execute stage 16 includes a number of processing units, for executing different classes of processing operation. For example the execution units may include an arithmetic/logic unit (ALU) 20 for performing arithmetic or logical operations; a floating-point unit 22 for performing operations on floating-point values, a branch unit 24 for evaluating the outcome of branch operations and adjusting the program counter which represents the current point of execution accordingly; and a load/store unit 28 for performing load/store operations to access data in a memory system 8, 30, 32, 34. In this example the memory system include a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or memory management mechanisms.

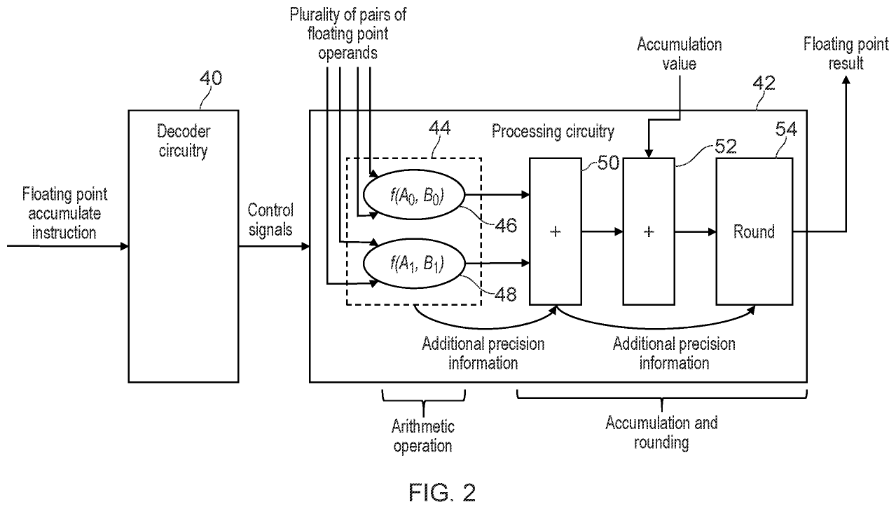

FIG. 2 schematically illustrates an apparatus according to some configurations of the present techniques. The apparatus includes decoder circuitry 40 and processing circuitry 42. The decoder circuitry is responsive to a floating point accumulate instruction specifying a plurality of pairs of input operands and an accumulation source to generate control signals that trigger the processing circuitry 42 to perform a floating point accumulate operation. The processing circuitry 42 is provided with a plurality of arithmetic combination units 44 including a first arithmetic combination unit 46 and a second arithmetic combination unit 48. Each of the arithmetic combination units 44 receives a pair of input operands and produces an arithmetic result. The first arithmetic combination unit 46 receives inputs A₀ and B₀ and generates an arithmetic result f(A₀, B₀), where f(A₀, B₀) is any arithmetic function that receives two inputs and combines them to generate an arithmetic result (e.g., multiplication, division, addition, etc.). The second arithmetic combination unit 48 receives inputs A₁ and B₁ and generates an arithmetic result f(A₁, B₁). The arithmetic results from the arithmetic combination units 44 are provided to summation circuitry 50 which performs an arithmetically precise summation of the arithmetic results to generate an intermediate result. The intermediate result maintains an accurate arithmetic representation of all significant binary digits calculated by the sum of the arithmetic results and is independent of an order in which the arithmetic results are received. The arithmetic representation of the arithmetic results may take several forms and may be represented by explicit binary digits or may be provided with one or more sticky bits representative of a combined contribution of a number of non-explicitly represented bits of the arithmetic results. The intermediate result is provided to accumulation circuitry 52 along with an accumulation value retrieved from an accumulation source specified in the floating point accumulate instruction. The accumulation circuitry 52 accumulates the intermediate result value with the accumulation value to produce the unrounded result which is passed to rounding circuitry 54 which performs a single rounding operation. The single rounding operation is based on the unrounded result output by the accumulation circuitry 52 and accounts for additional precision information propagated from one or more of the arithmetic combination units 44, the summation circuitry 50 and the accumulation circuitry 52. The rounding circuitry 54 outputs the floating point result to the accumulation source.

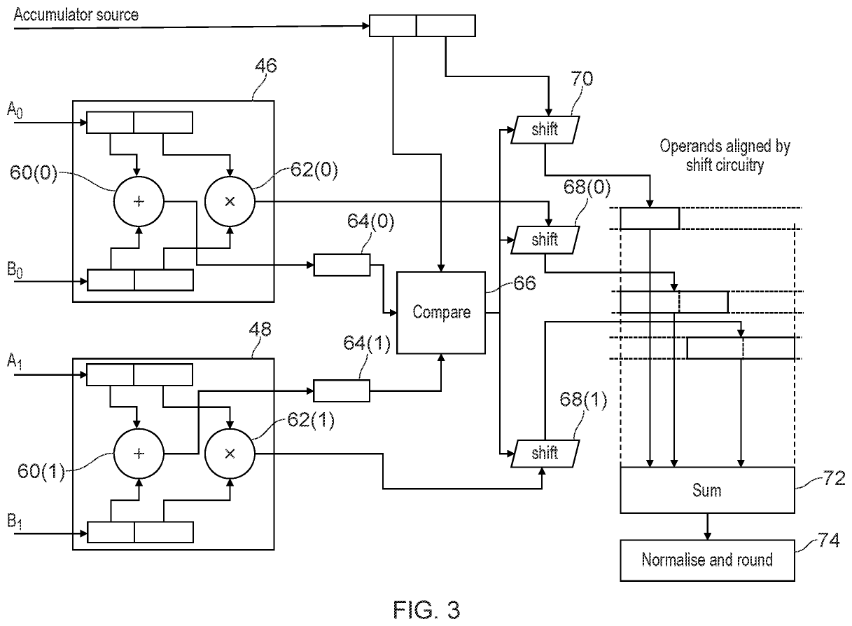

FIG. 3 schematically illustrates further details of an apparatus according to some configurations of the present techniques. The apparatus is provided with a first arithmetic combination unit 46 and a second arithmetic combination unit 48. Each of the arithmetic combination units is provided with floating point multiplication circuitry comprising addition circuitry 60 and multiplication circuitry 62. The floating point operands comprise a significand portion and an exponent portion. In the illustrated configuration the significand portion is provided as the least significant portion and the exponent portion is provided as the most significant portion. Multiplication of floating point numbers is achieved by multiplying the significand portions, using the multiplication circuitry 62 and addition of the exponent portions using the summation circuitry 60. The first arithmetic combination unit receives floating point operands A₀ and B₀. Each of A₀ and B₀ comprise an exponent portion and a significand portion. The exponent portion of input A, and the exponent portion of the input B₀ are provided to the addition circuitry 60(0) and are added to generate a first summed exponent 64(0). The significand portion of input A₀ and the significand portion of the input B₀ are provided to the multiplication circuitry 62(0) which generates a first multiplied result that is provided to shift circuitry 68(0). The second arithmetic combination unit receives floating point operands A₁ and B₁. Each of A₁ and B₁ comprise an exponent portion and a significand portion. The exponent portion of input A₁ and the exponent portion of the input B₁ are provided to the addition circuitry 60(1) and are added to generate a second summed exponent 64(1). The significand portion of input A₁ and the significand portion of the input B₁ are provided to the multiplication circuitry 62(1) which generates a second multiplied result that is provided to shift circuitry 68(1). The processing circuitry is also provided with an accumulator source which stores a floating point value having an accumulator significand portion and an accumulator exponent portion. The accumulator exponent portion, the first summed exponent 64(0) and the second summed exponent 64(1) are provided to comparison circuitry 66 which uses a predetermined common magnitude to identify a shift amount required to align each of the accumulator, the first multiplied result, and the second multiplied result. The accumulator shift circuitry receives the significand portion of the accumulator source and shifts the accumulator significand by an amount identified by the comparison circuitry 66. The first shift circuitry 68(0) receives the first multiplied result and shifts it by an amount identified by the comparison circuitry 66. The second shift circuitry 68(1) receives the second multiplied result and shifts it by an amount identified by the comparison circuitry 66. The shifted values generated by the accumulator shift circuitry 70, the first shift circuitry 68(0) and the second shift circuitry 68(1) are schematically illustrated on the right hand side of FIG. 3. These values are aligned relative to the common magnitude and are passed to the summation circuitry 72 which sums the aligned outputs of the shift circuitry. The output of the summation circuitry is then passed to the normalisation circuitry 74 which performs the steps of normalisation and rounding.

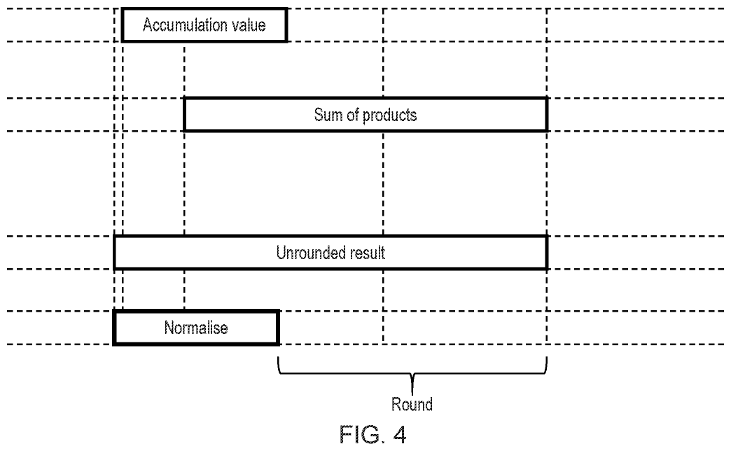

FIGS. 4 to 7 schematically illustrate further details of the alignment of the accumulator to the intermediate result (sum of products) for different relative magnitudes of the accumulator and the sum of products.

FIG. 4 schematically illustrates a first case in which the sum of products has a magnitude that is comparable to the accumulation value such that there is some overlap in the bits used to represent the sum of products and the bits used to represent the accumulation value. In the illustrated configuration, the least significant portion of the accumulation value overlaps with the most significant portion of the sum of products. In this case, the values of both the accumulation value and the sum of products directly influence the normalised result. The accumulation value and the sum of products are added to one another to generate the unrounded result which has sufficient bit width to accommodate all the numerical precision information propagated from the arithmetic combination units and from the accumulation value. The unrounded result is then normalised and rounded to generate the accumulated result.

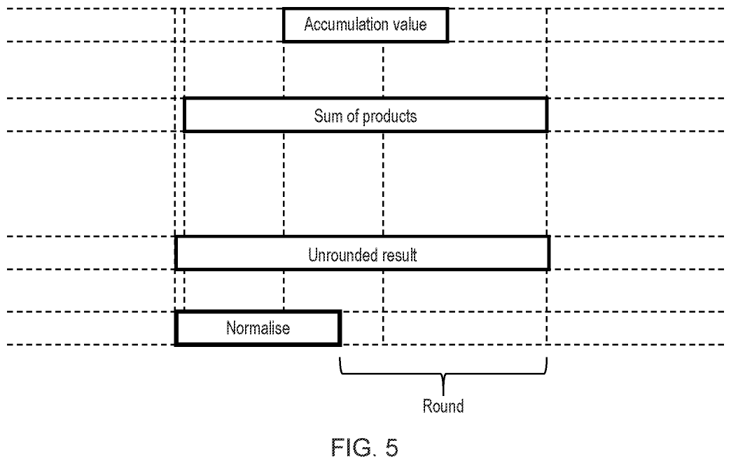

FIG. 5 schematically illustrates a second case in which the sum of products has a magnitude that is comparable to the accumulation value such that there is some overlap in the bits used to represent the sum of products and the bits used to represent the accumulation value. In the illustrated configuration, all the bits of the accumulation value overlap with some of the bits that represent the sum of products. In this case, the values of both the accumulation value and the sum of products directly influence the normalised result. The accumulation value and the sum of products are added to one another to generate the unrounded result which has sufficient bit width to accommodate all the numerical precision information propagated from the arithmetic combination units and from the accumulation value. The unrounded result is then normalised and rounded to generate the accumulated result.

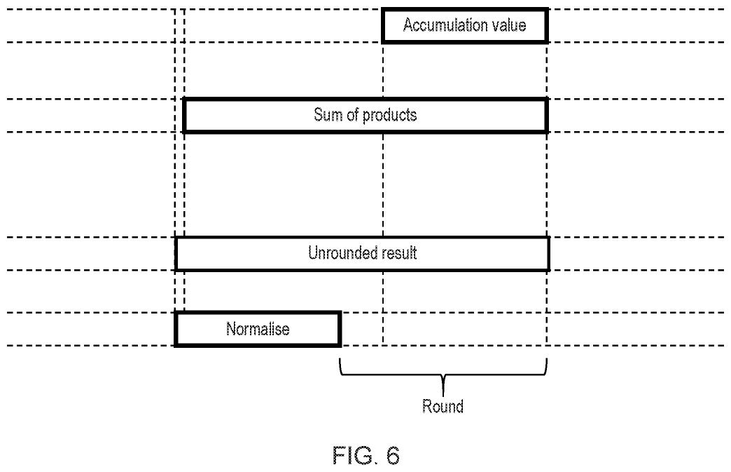

FIG. 6 schematically illustrates a third case in which the sum of products has a magnitude that is comparable to the accumulation value such that there is some overlap in the bits used to represent the sum of products and the bits used to represent the accumulation value. In the illustrated configuration, all the bits of the accumulation value overlap with some of the bits that represent the sum of products. In this case, the accumulation value is aligned at the least significant end of the sum of products and the sum of products has sufficient bit width that the accumulation value does not directly overlap with the normalised result. In this case, the accumulation value may directly influence the value of the normalised result, for example, if the sum of the accumulation value and the least significant bits of the sum of products are sufficiently large that the sum of these portions modifies a value of the more significant bits of the unrounded result. Alternatively, the accumulation value may indirectly influence the normalised result by causing the values of the unrounded result to influence the rounding applied to generate the normalised result. The unrounded result is generated from the sum of the accumulation value and the sum of products. The result is then normalised and rounded.

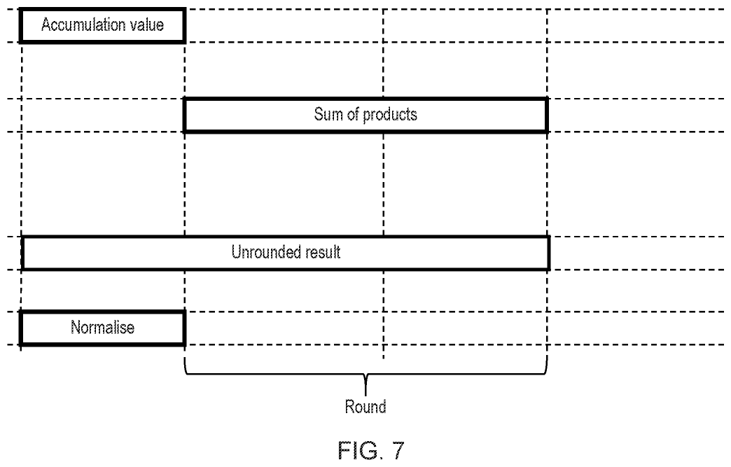

FIG. 7 schematically illustrates a fourth case in which the sum of products has a magnitude that is less than the accumulation value such that there is no overlap between the accumulation value and the sum of products. In this case, the sum of products does not directly influence the normalised result. The unrounded result is generated by summing the accumulation value and the sum of products. As there is no overlap between the accumulation value and the sum of products, there is no actual summation to be performed and the unrounded result is merely the combination of the accumulation value in the most significant portion of the unrounded result and the sum of products in the least significant portion of the unrounded result. The unrounded result is then normalised and rounded to generate the normalised value. The value of the sum of products can therefore indirectly affect the normalised result through the process of rounding.

It would be readily apparent to the person of ordinary skill in the art that the cases set out in FIGS. 4 to 7 are provided by way of example and that alternative alignments of the accumulation value and the sum of products may occur during use of the processing circuitry described herein.

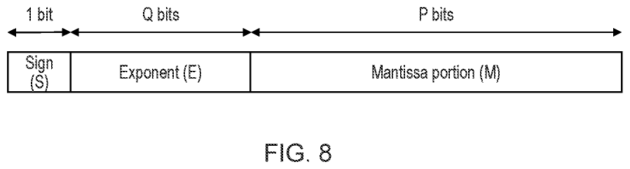

FIG. 8 schematically illustrates a representation of a floating point value according to some configurations of the present techniques. The floating point value may be represented as a single sign bit S, an exponent E, and a mantissa portion M. The exponent portion is represented using Q bits and the mantissa portion is represented using P bits. The significand is defined based on the mantissa with an additional implicit most significant bit. Where the floating point number is represented using normal representation, the significand portion comprises the mantissa portion with an additional logical one placed in at a most significant position in front of the mantissa portion, e.g., for a mantissa portion given by XXXX, the significand portion is given by 1.XXXX where X is representative of either a logical one or a logical zero. Where the floating point number is represented using sub-normal representation, the significand portion comprises the mantissa portion with an additional logical zero placed as the most significant bit, e.g., for a mantissa portion given by XXXX, the significand portion is given by 0.XXXX where X is representative of either a logical one or a logical zero. The floating point value represented by the floating point representation of FIG. 8 is dependent on the format being used. Where the floating point representation uses normal format, the floating point value represented by the floating point number represented in FIG. 8 is defined as:

$$FP = {( - 1 )}^{S} \times ( 1 + {\sum }_{i = 0}^{P - 1} {M}_{P - i} \times {2}^{- ( i + 1 )} ) \times {2}^{E - b} ,$$

where b is a predetermined exponent bias. Where the floating point representation uses sub-normal format, the floating point number represented in FIG. 8 is defined as:

$$FP = {( - 1 )}^{S} \times ( 0 + {\sum }_{i = 0}^{P - 1} {M}_{P - i} \times {2}^{- ( i + 1 )} ) \times {2}^{E - b} .$$

It would be readily apparent to the person of ordinary skill in the art that the above floating point formats are provided by way of example and alternative floating point formats may be supported.

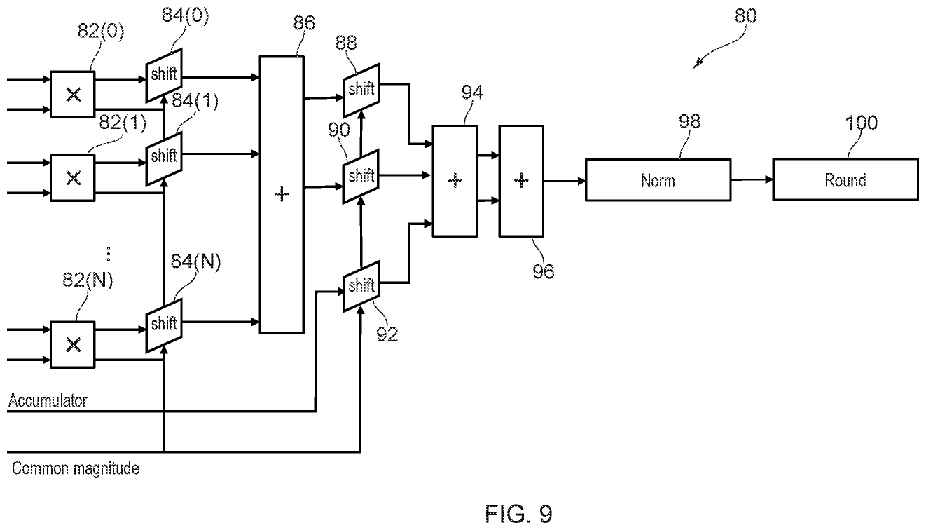

FIG. 9 schematically illustrates an apparatus 80 according to some configurations of the present techniques. The apparatus 80 is provided with arithmetic combination units 82, alignment circuitry 84, summation circuitry 86, carry shift circuitry 90, summation shift circuitry 88, accumulator shift circuitry 92, first accumulation circuitry 94, second accumulation circuitry 96, normalisation circuitry 98 and rounding circuitry 100. The arithmetic combination units 82 including first arithmetic combination unit 82(0), second arithmetic combination unit, to Nth arithmetic combination unit 82(N) each receive a pair of floating point input operands. Each of the arithmetic combination units 82 multiplies the pair of floating point input operands to generate an arithmetic result which comprises a sign bit and an exponent portion and a significand portion. The arithmetic results are fed to the shift circuitry 84 which comprises first shift circuitry 84(0), second shift circuitry 84(1) to Nth shift circuitry 84(N). The shift circuitry 84 receives a significand portion of the arithmetic result from the corresponding arithmetic combination unit, an exponent portion from the corresponding arithmetic combination unit and the common magnitude. The shift circuitry 84 includes comparison circuitry (not illustrated) that receives the exponent calculated by the arithmetic combination units 82 and the common magnitude and determines a shift value by which the significand portion should be shifted based on the difference between the common magnitude and the exponent values to generate arithmetic values aligned to the same magnitude which are passed to the summation circuitry 86. The summation circuitry 86 receives the aligned arithmetic results and performs a numerically precise summation of those results. In the illustrated configuration the summation circuitry comprises a carry-save adder which outputs the arithmetically precise result in carry-sum format. The carry portion of the arithmetically precise result is passed to the carry shift circuitry 90 and the sum portion of the arithmetically precise result is passed to the summation shift circuitry 88. The significand portion of the accumulator is provided to the accumulator shift circuitry 92 along with an exponent portion of the accumulator. The accumulator shift circuitry 92, the carry shift circuitry 90 and the summation shift circuitry 88 each receive an indication of a shift amount based on the exponent portion of the accumulator and the common magnitude, and perform a shift to align the carry portion of the arithmetically precise result, the sum portion of the arithmetically precise result, and the accumulator significand portion. As a result, the accumulator significand and the carry sum output of the summation circuitry 86 are shifted to align them based on the common magnitude. The aligned values are then fed into the first accumulation circuitry 94 which comprises a carry-save adder to perform the accumulation and outputs the accumulation in carry sum format. The carry portion and the sum portion are then fed into the second accumulation circuitry 96 which comprises a carry propagate adder to output the unrounded result. The unrounded result is then normalised by normalisation circuitry 98 and rounded by rounding circuitry 100.

In some alternative configurations, the common magnitude may be further modified by a scaling factor, for example, provided as part of the floating point accumulation operation and added to or subtracted from the common magnitude when calculating the shift values.

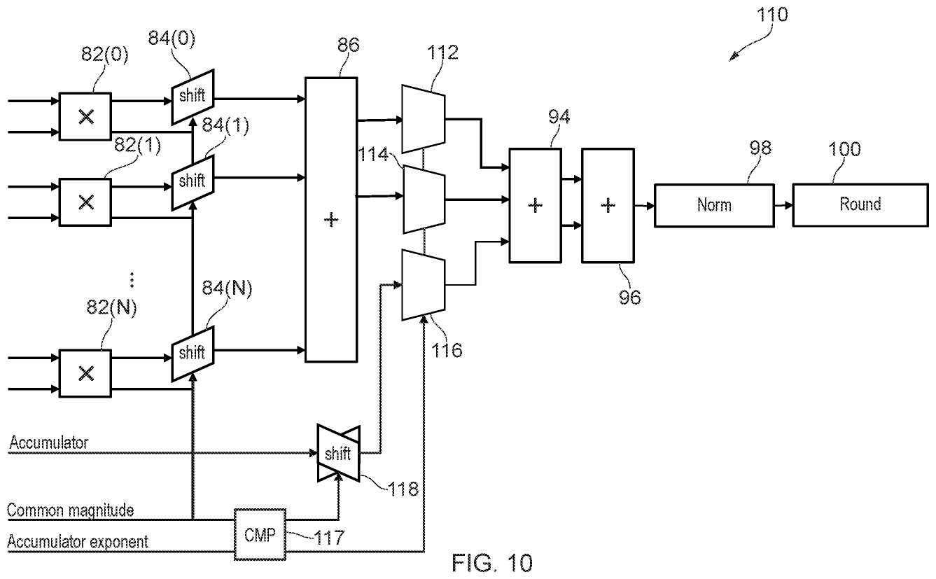

FIG. 10 schematically illustrates an apparatus 110 according to some configurations of the present techniques. The apparatus 110 is similar to the apparatus 80 described in relation to FIG. 9. Elements of apparatus 110 that are the same as those of apparatus 80 are provided with same reference numerals and description of those components is provided in relation to FIG. 9. FIG. 10 differs from FIG. 9 in that the accumulator is provided to multi-directional shift circuitry 118 which aligns the accumulator to a common magnitude based on a comparison of the accumulator exponent and the common magnitude. The comparison is performed by comparison circuitry 117. The alignment of the arithmetic results relative to the common magnitude is provided by shift circuitry 84. The carry shift circuitry 90, summation shift circuitry 88, and accumulator shift circuitry 92 are replaced by carry multiplexer circuitry 114, sum multiplexer circuitry 112 and accumulator multiplexer circuitry 116 before being fed into the first accumulation circuitry. The carry multiplexer circuitry 114, summation multiplexer circuitry 112 and accumulator multiplexer circuitry 116, each choose one of two alternatives corresponding to a first case wherein the accumulator exponent magnitude is larger than the predetermined common magnitude as determined by comparison circuitry 117, and a second case wherein the accumulator exponent magnitude is not larger than the predetermined common magnitude as determined by comparison circuitry 117. For the case in which the accumulator exponent magnitude is larger than the predetermined common magnitude, the accumulator multiplexer circuitry 116 aligns the shifted accumulator significand provided by shifter 118 to a most significant bit position, and the summation multiplexer circuitry 112 and the carry multiplexer circuitry 114 align the carry sum representation to a right shifted bit position, which is of lesser significance, as determined by their magnitude, as would be well understood by those skilled in the art of floating-point design. In the case the accumulator exponent magnitude is not larger than the predetermined common magnitude, the summation multiplexer 112 and the carry multiplexer 114 align the carry sum representation to a most significant bit position, and the accumulator multiplexer circuitry 116 aligns the shifted accumulator significand provided by shifter 118 to a right shifted bit position, which is of lesser significance, determined by its magnitude, as would be well understood by those skilled in the art. The outputs of the summation multiplexer circuitry 112, the carry multiplexer circuitry 114, and the accumulator multiplexer circuitry 116 are each provided to first accumulation circuit 94. Rather than aligning the arithmetic results to a common magnitude prior to summation and then aligning either the intermediate result or the accumulator subsequent to the summation (as is done in FIG. 9), the arithmetic results are each aligned once to the common magnitude and the accumulator is either left or right shifted dependent on the relative magnitude of the accumulator to the predetermined common magnitude. This approach eliminates the need for the carry shift circuitry 90, summation shift circuitry 88, and accumulator shift circuitry 92.

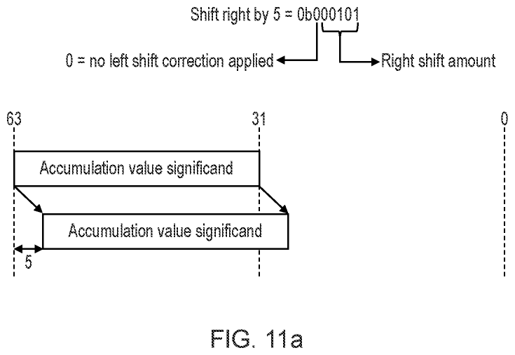

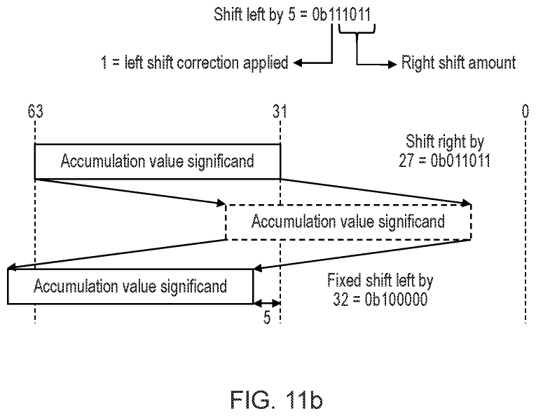

FIGS. 11a and 11b schematically illustrate an example operation of the multi-directional shift circuitry 118. The multi-directional shift circuitry is capable of shifting the accumulator significand to the right (a first shift direction) and to the left (a second shift direction). The shift amount in the first direction and/or the second direction is controlled through provision of a shift amount represented in twos complement notation. Twos complement notation is one possible binary representation which allows negative numbers to be represented. In standard binary representation, the i-th bit is representative of 2ⁱ so that, for example, the binary value 1010 is equal to 1×2³+0×2²+1×2¹+0×2⁰=12. In twos complement notation, the most significant bit is negated such that the same binary value, when interpreted as a twos complement binary number is equal to (−1)×2³+0×2²+1×2¹+0× 2⁰=−6. The multi-directional shift circuitry determines the shift amount based on the twos complement notation with the most significant bit identifying whether or not a left shift by a predetermined maximum amount should be performed and the remaining bits identifying the amount of right shift.

FIG. 11a schematically illustrates an example of a shift by a twos complement value of 0b000101=5. In this case, the most significant bit is zero so there is no left shift. On the other hand, the remaining bits represent a binary value of 5 and cause a right shift of 5 to be applied. FIG. 11b schematically illustrates an example of a shift by a twos complement value of 0b111011=−5. In this case, the most significant bit is one so there is a left shift by 32 bits (a right shift of −32). In addition, the remaining bits add up to a right shift value of 27. The total shift is therefore provided as a right shift of 27 bits and a left shift of 32 bits resulting in a total shift of 5 bits to the left (−5 bits to the right). The combination of a single fixed shift in one direction and a variable shift in the other direction provides a flexible way to allow both left and right shifting without having to implement a full left shift circuit and a full right shift circuit.

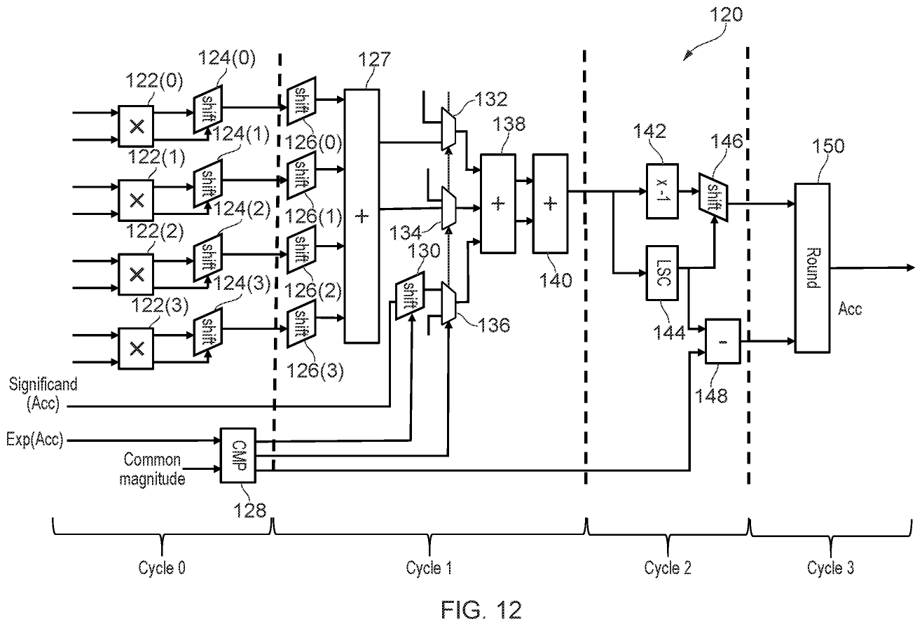

FIG. 12 schematically illustrates an apparatus 120 according to some configurations of the present techniques. The apparatus is arranged as a multi-cycle processing apparatus arranged to perform the floating point accumulate operation of a plurality of processing cycles. The vertical dashed lines illustrate the boundaries between the different processing cycles. The processing circuitry is provided with arithmetic combination circuitry 122, first alignment circuitry 124, second alignment circuitry 126, summation circuitry 127, comparison circuitry 128, multi-directional shift circuitry 130, sum multiplexer circuitry 132, carry multiplexer circuitry 134, accumulator multiplexer circuitry 136, first accumulation circuitry 138, second accumulation circuitry 140, sign change circuitry 142, leading sign count circuitry 144, normalisation shifting circuitry 146, subtraction circuitry 148, and rounding circuitry 150.

During the first cycle (cycle 0), each arithmetic combination circuit 122 receives a pair of floating point operands and performs a floating point multiplication operation as described above. The arithmetic combination circuits 122 each output an arithmetic result formatted using a twos complement representation which is passed to the first alignment circuitry 124 which performs a first alignment stage. The twos complement representation is retained until the sign change circuitry which is utilised in the third cycle (cycle 2). The output of the first alignment stage is stored and is passed to the second alignment circuitry in the second cycle (cycle 1). In addition, during the first cycle (cycle 0), the accumulator exponent is compared against a predetermined common magnitude to determine a shift value for the accumulator significand using compare circuit 128. In alternate embodiments, the predetermined common magnitude may be replaced by a non-predetermined common magnitude based on the results of the arithmetic combination operations.”. The accumulator shift value is output as a twos complement value to be provided to the multi-directional shift circuitry 130 along with the significand of the accumulator. The greater of the predetermined common magnitude and the accumulator exponent value is selected by compare circuit 128 and then passed to the subtraction circuitry 148 during the third cycle (cycle 2).

During the second cycle (cycle 1), the second alignment circuitry 126 receives the partially aligned arithmetic results generated by the first alignment circuitry 124. The second alignment circuitry 126 generates a set of aligned arithmetic results which are passed to the summation circuitry 127. Splitting the alignment over the two clock cycles allows some alignment to be performed during the first clock cycle (cycle 0) whilst reducing the amount of data that needs to be passed between clock cycles. The summation circuitry 127 takes the form of a carry-save adder which performs an arithmetically precise summation of the arithmetic results and outputs the intermediate result in carry sum format. The carry portion of the carry sum format is fed into the carry multiplexer circuitry 134 and the sum portion of the carry sum format is fed into the sum multiplexer circuitry 132. Also during the second cycle, the significand portion of the accumulator is fed into the mutli-directional shift circuitry 130 (as described in relation to FIG. 11) which performs a shift to align the accumulator based on the predetermined common magnitude. The output of the multi-directional shift circuitry 130 is fed into the accumulator multiplexer circuitry 136. Sum multiplexer circuitry 132, carry multiplexer circuitry 134, and accumulator multiplexer circuitry 136, each choose one of two alternatives corresponding to a first case wherein the accumulator exponent magnitude is larger than the predetermined common magnitude as determined by comparison circuitry 128, and a second case wherein the accumulator exponent magnitude is not larger than the predetermined common magnitude as determined by the comparison circuitry 128. For the case in which the accumulator exponent magnitude is larger than the predetermined common magnitude, the accumulator multiplexer circuitry 136 aligns the shifted accumulator significand provided by shifter 130 to a most significant bit position, and the sum multiplexer circuitry 132 and the carry multiplexer circuitry 134 align the carry sum representation to a right shifted bit position, which is of lesser significance, as determined by their magnitude, as would be well understood by those skilled in the art of floating-point design. In the case the accumulator exponent magnitude is not larger than the predetermined common magnitude, the sum multiplexer 132 and the carry multiplexer 134 align the carry sum representation to a most significant bit position, and the accumulator multiplexer circuitry 136 aligns the shifted accumulator significand provided by shifter 130 to a right shifted bit position, which is of lesser significance, determined by its magnitude, as would be well understood by those skilled in the art. The outputs of the sum multiplexer circuitry 132, the carry multiplexer circuitry 134, and the accumulator multiplexer circuitry 136 are each provided to first accumulation circuit 138 which takes the form of a carry-save adder and, subsequently, into the second accumulation circuitry 140 which takes the form of a carry propagate adder. The first accumulation circuitry and the second accumulation circuitry accumulate the intermediate result value with the accumulator value to produce the unrounded result. The unrounded result is passed to the third cycle (cycle 2) along with the output from comparison circuitry 128. The output from the comparison circuitry 128 may take a value of 1) the common magnitude when the common magnitude is greater than or equal to the accumulator exponent, 2) a value EXP_LSH when the accumulator exponent is greater than the common magnitude and if the accumulator exponent minus the common magnitude is less than a maximum left shift value, where EXP_LSH is equal to the common magnitude added to the maximum left shift value, and 3) the accumulator exponent otherwise.

During the third cycle (cycle2), the accumulated value output by the second accumulator circuit 140, which forms part of the unrounded result, is fed into the sign change circuitry 142 as an input value and the leading sign count circuitry 144 as an input value. The sign change circuitry 142 detects whether the input value, which is formatted using a twos complement representation, is positive or negative. This can be achieved by determining if the most significant portion is a zero (indicating a positive value) or one (indicating a negative value). Where the input value is negative, the input value is negated, for example, by well-known means for arithmetic negation of a value represented in twos complement notation and the negative sign is recorded as the sign bit for the output accumulator value. Where the input value is positive, arithmetic negation is not required and the positive sign is recorded as the sign bit for the output accumulator value. The leading sign count circuitry 144 receives the input value and counts the number of leading bits that take a same value as the most significant bit. This count is indicative of a number of bits that can be removed from the most significant end of the accumulated value by performing a left shift using the shift circuitry 146. Where the leading bit is one, the number of places by which the accumulated value is left shifted is equal to the leading sign count minus 1 for cases where the accumulated value is a negative power of two, and is equal to the leading sign count otherwise, where the leading bit is zero, the number of places by which the accumulated value is left shifted is equal to the leading sign count (without subtracting one). By way of a first example, if the accumulated value input into the leading sign count circuitry was 00001101, then the leading sign count would be 4 indicating that there are 4 leading bits that take a same value as the most significant bit. Because the leading bit is zero, this value is already positive so there would be no multiplication by minus one in the sign change circuitry 142. As a result, the output from the shift circuitry 146 is a value of 11010000. By way of a second example, if the accumulated value input to the leading sign count circuitry was 11000000, then the leading sign count would be 2 indicating that there are 2 leading bits that take a same value as the most significant bit. Because the leading bit is one, this value is negative so the accumulated value is multiplied by minus one by the sign change circuitry 142. Because the leading bit is one and the leading sign count is 2, the shift value received by the shift circuitry 146 indicates a left shift of 1 place. As a result, the output from the sign change circuitry 142 would be 01000000 and the output from the shift circuitry 146 would be 10000000. The output from the leading sign count circuitry is also provided to subtraction circuitry 148 along with the output of comparator 128 and is used to calculate the exponent value for the accumulator value to be provided to the rounding circuitry 150. It would be readily apparent to the person of ordinary skill in the art that the examples provided are for illustrative purpose only and that the circuitry may be responsive to any number of leading zeros or leading ones.

During the fourth cycle (cycle 3), the normalised value and the exponent are provided to the rounding circuitry which performs rounding according to a particular rounding mode used by the processing circuitry and the normalised rounded accumulator value is output in a floating point format. The accumulator value that is output may include any accumulator exponent increment required by the rounding operation. The floating point format may also include any special values that can be represented by the floating point format, e.g., NaN, INF which may be detected as part of the normalisation and/or rounding operations.

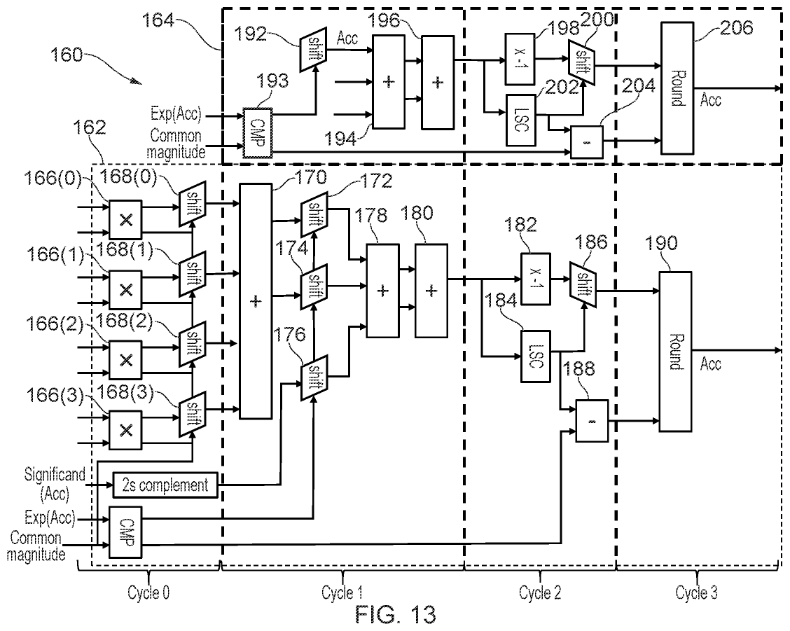

FIG. 13 schematically illustrates an apparatus 160 according to some configurations of the present techniques. The apparatus 160 is arranged to perform a dot product floating point accumulation operation requiring 4 pairs of floating point input operands (a DOT4 operation) and is arranged to perform two dot product floating point accumulation operations each requiring 2 pairs of floating point input operands (two DOT2 operations). The apparatus 160 comprises processing circuitry 162 configured to perform the DOT4 operation over a plurality of cycles for example, as described in relation to FIGS. 9, 10, and 12. The apparatus is also provided with some additional circuitry 164 which is utilised during the second, third and fourth cycle (cycle 1, cycle 2, and cycle 3) when performing the two DOT2 operations.

The operation of the circuitry when performing the DOT4 operation is described above and is not repeated for reasons of conciseness. When performing the two DOT2 operations, the arithmetic combination circuits 166 and the shift circuitry 168 can be split between the two DOT2 operations. For example, when performing the DOT4 operation, the first arithmetic combination unit 166(0), the second arithmetic combination unit 166(1), the third arithmetic combination unit 166(2) and the fourth arithmetic combination unit 166(3) are all used to generate arithmetic results to be aligned by the respective shift circuitry 168 and combined by the summation circuitry 170 for the DOT4 operation. When two DOT2 operations are performed, the first arithmetic combination unit 166(0), the second arithmetic combination unit 166(1), the first shift circuitry 168(0), and the second shift circuitry 168(1) can be used to calculate the arithmetic results for the first DOT2 operation. In subsequent cycles the arithmetic results for the first DOT2 operation can be accumulated, along with the accumulator value shifted by the accumulator shift circuitry 176, by the first accumulation circuitry 178 and the second accumulation circuitry 180. As there are only two arithmetic results, these can be directly combined by the accumulation circuitry without the need to be summed by the summation circuitry 170. The output from the second accumulation circuitry 180 can then be normalised using the sign negation circuitry 182, the leading sign count circuitry 184, the shift circuitry 186, the subtraction circuitry 188, and rounded by the rounding circuitry 190.

The third arithmetic combination unit 166(2), the fourth arithmetic combination unit 166(3), the third shift circuitry 168(2), and the fourth shift circuitry 168(3) can be used to calculate the arithmetic results for the other DOT2 operation. Additional circuitry 164 is then provided for the remaining cycles to perform the summation stage, the accumulation stage, and the rounding stage of the second DOT2 operation. In subsequent cycles the arithmetic results for the second DOT2 operation can be accumulated, along with the accumulator value shifted by the accumulator shift circuitry 192, for example, based on comparison of an accumulator exponent and a common magnitude using comparison circuitry 193, by the first accumulation circuitry 194 and the second accumulation circuitry 196. The output from the second accumulation circuitry 196 can then be normalised using the sign negation circuitry 198, the leading sign count circuitry 202, the shift circuitry 200, the subtraction circuitry 204 which receives input from the comparison circuitry 193, and rounded by the rounding circuitry 206.

It would be readily apparent to the skilled person that the circuit illustrated in FIG. 13 can be modified so that different stages of alignment can be carried out in different cycles, for example, as illustrated in relation to FIG. 12 and that multi-directional shift circuitry could be used in place of the shift circuitry 176 and the shift circuitry 192, for example, as described in relation FIGS. 11a and 11b. Further, it would be readily apparent to the person of ordinary skill in the art that the accumulator input to circuitry block 164 may be either the same accumulator or a different accumulator than the accumulator provided as an input to block 162 and that techniques previously described enable the use of these same or different accumulator inputs to calculate different accumulations.

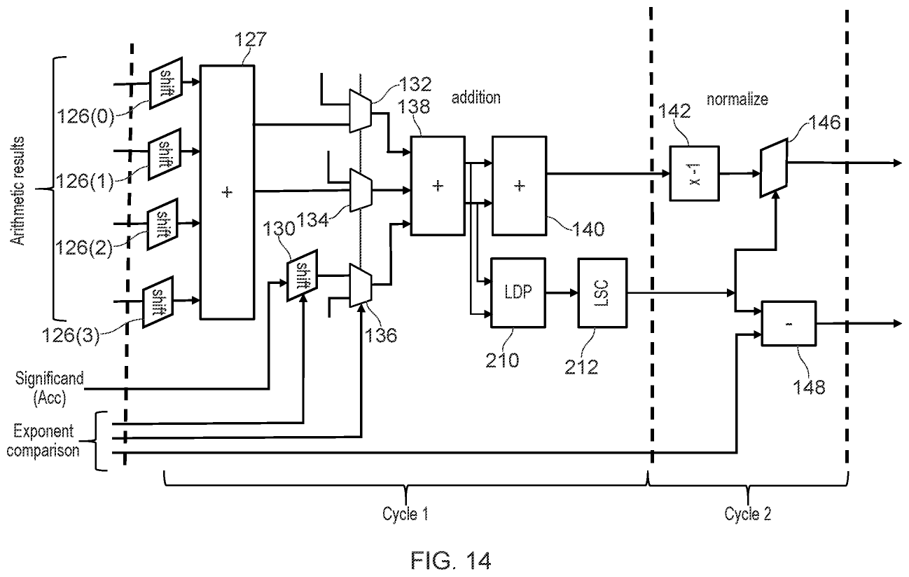

FIG. 14 schematically illustrates a further modification to an apparatus according to some configurations of the present techniques. The modification is illustrated based on the configuration of FIG. 12 and replaces the circuitry illustrated in the second and third (cycle 1 and cycle 2) and the components used during the first cycle (cycle 0) and the fourth cycle (cycle 3) are omitted for clarity of presentation. The modification uses leading digit prediction circuitry 210 to predict the location of the most significant bit of the result of the final accumulation step based on the inputs to the second accumulation circuit 140. The output of the leading digit prediction circuitry is passed to the leading sign count circuitry 212 which is provided in cycle 1 rather than cycle 2. The leading sign count circuitry infers the shift amount directly from the leading digit prediction circuitry. The determination of the leading digit position is performed in parallel with the accumulation in cycle 1 and the output of the leading sign count circuit is passed to cycle 2 to feed into the shift circuitry 146 and the subtraction circuitry 148. It would be readily apparent to the person of ordinary skill in the art that the same modification could be incorporated in the circuitry of FIG. 13 in both sets of accumulation and normalisation circuitry. Further, it would be readily apparent to the person of ordinary skill in the art that circuits 210 and 212 may complete calculations before or after circuit 140 and that some portion of circuits 210 and 212 may be implemented in cycle 2 rather than cycle 1, accordingly.

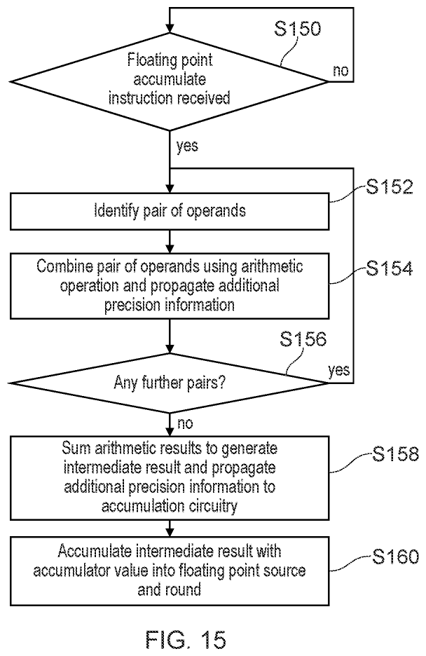

FIG. 15 schematically illustrates a sequence of steps carried out according to some configurations of the present techniques. Flow begins at step S150 where it is determined if a floating point accumulation instruction has been received. If, at step S150, it is determined that a floating point accumulation instruction has not been received then flow remains at step S150. If, at step S150, it is determined that a floating point accumulate instruction has been received, then flow proceeds to step S152 where a pair of operands identified in the floating point accumulate instruction are retrieved. Flow then proceeds to step S154, where the pair of operands are combined using an arithmetic combination operation and additional precision information is propagated. Flow then proceeds to step S156 where it is determined if there are any further pairs of operands. If, at step S156, it is determined that there are further pairs of operands then flow returns to step S152. If, at step S156, it is determined that there are no further pairs of operands, then flow proceeds to step S158. At step S158 the arithmetic results of the arithmetic combination operations are summed to generate the intermediate result and additional precision information is propagated to the accumulation circuitry. Flow then proceeds to step S160, where the intermediate result is accumulated with the accumulator value and rounding occurs. It would be readily apparent to the person of ordinary skill in the art that, whilst step S152, S154, and S156 are illustrated as occurring sequentially, this is for illustrative purpose only and, in some configurations these steps may be performed in parallel for all pairs of operands.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

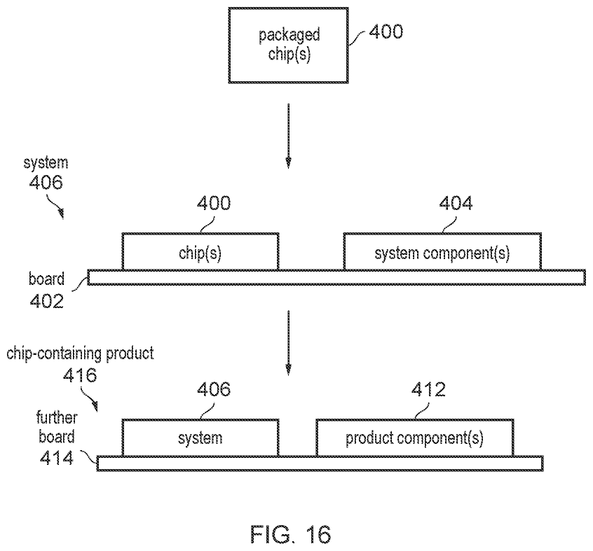

As shown in FIG. 16, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus, a system, a chip containing product, a method and a medium, the apparatus comprises decoder circuitry responsive to a floating point accumulate instruction identifying pairs of floating point operands and an accumulation source, and processing circuitry comprising a plurality of arithmetic combination units to perform an arithmetic operation to combine the pairs of operands, and summation circuitry to perform an arithmetically precise summation operation to calculate an intermediate result by summing results generated by the arithmetic combination units. The intermediate result is independent of an order in which the arithmetic results are summed. The processing circuitry comprises accumulation circuitry to accumulate the intermediate result into the accumulation source and rounding circuitry to perform a rounding operation after accumulating, and is configured to propagate additional precision information relating to the arithmetic results, the intermediate result, and/or the prior accumulation value to the rounding circuitry.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:

Clause 1. An apparatus comprising:
decoder circuitry responsive to a floating point accumulate instruction identifying a plurality of pairs of floating point operands and an accumulation source, to generate control signals to trigger a floating point accumulation operation; and
processing circuitry responsive to the control signals, to perform the floating point accumulation operation, the processing circuitry comprising:
a plurality of arithmetic combination units configured, for each pair of operands of the plurality of pairs of floating point operands, to perform an arithmetic operation to combine that pair of operands;
   summation circuitry configured to receive arithmetic results generated by each of the plurality of arithmetic combination units and to perform an arithmetically precise summation operation to calculate an intermediate result by summing the arithmetic results, wherein the intermediate result is independent of an order in which the arithmetic results are summed;
   accumulation circuitry configured to retrieve a prior accumulation value from the accumulation source and to accumulate the intermediate result into the accumulation source; and
   rounding circuitry configured to perform a rounding operation after accumulating the intermediate result into the accumulation source,
wherein the processing circuitry is configured to propagate additional precision information to the rounding circuitry, the additional precision information relating to at least one of the arithmetic results, the intermediate result, or the prior accumulation value.
   Clause 2. The apparatus of clause 1, wherein the processing circuitry is configured to defer rounding of results of the arithmetic operation for each pair of operands until the rounding operation, and to defer rounding of results of the arithmetically precise summation operation until the rounding operation.
   Clause 3. The apparatus of clause 1 or clause 2, wherein:
the processing circuitry is configured to support at least one floating point format specifying at least a significand portion having a significand bit width and an exponent portion having an exponent bit width; and
the additional precision information comprises additional significand information extending a bit width of at least one of the arithmetic results by at least one additional bit relative to a bit width of the significand portion of the plurality of pairs of floating point operands.
   Clause 4. The apparatus of clause 3, wherein the bit width of the significand portion of each of the arithmetic results is greater than or equal to a sum of the bit width of the significand portions of each of the pair of operands from which that arithmetic result is generated.
   Clause 5. The apparatus of clause 3 or clause 4, wherein the processing circuitry comprises alignment circuitry to perform at least one alignment operation to align the arithmetic results to a common magnitude prior to the arithmetically precise summation operation.
   Clause 6. The apparatus of clause 5, wherein the common magnitude is determined based on at least one of:
a magnitude of a largest exponent of the arithmetic results; and
a summation of a maximum calculable arithmetic exponent and a characteristic multiplicity factor determined as a ceiling value of a base-2 logarithm of a multiplicity of the plurality of pairs of floating point operands.
   Clause 7. The apparatus of clause 6, wherein the summation circuitry is configured to output the intermediate result having an intermediate result bit width extended to comprise:
a most significant portion comprising sufficient bit width to store the significand portion of the prior accumulation value; and
a least significant portion having a bit width sufficient to store the intermediate result.
   Clause 8. The apparatus of clause 7, wherein the accumulation circuitry comprises accumulator alignment circuitry to perform an accumulator alignment operation to align the significand portion of the prior accumulation value to the common magnitude based on a magnitude stored in the exponent portion of the prior accumulation value and the common magnitude.
   Clause 9. The apparatus of clause 8, wherein when the magnitude stored in the exponent portion of the prior accumulation value exceeds the common magnitude by an amount greater than a bit width of the most significant portion, the accumulator alignment operation comprises aligning the significand portion of the prior accumulation value to the most significant portion.
   Clause 10. The apparatus of clause 8 or clause 9, wherein the accumulator alignment circuitry is configured:
to shift the significand portion of the prior accumulation value by a shift amount equal to a difference between the magnitude of the exponent portion of the prior accumulation value and the common magnitude;
when the shift amount indicates a shift in a first direction, to shift the significand of the prior accumulation value in the first direction by the shift amount; and
when the shift amount indicates a shift in a second direction opposite to the first direction, to shift the significand portion of the prior accumulation value in the first direction by an amount equal to a difference between a predetermined correction amount and the shift amount and to shift the significand portion of the prior accumulation value by the predetermined correction amount in the second direction.
   Clause 11. The apparatus of any of clauses 3 to 10, wherein:
the accumulation circuitry is configured to output an unrounded result obtained by accumulating the intermediate result into the accumulation source; and
the apparatus comprises normalising circuitry configured, prior to the rounding operation, to normalise the unrounded result.
   Clause 12. The apparatus of any preceding clause when dependent on clause 5, wherein:
the floating point accumulation operation is a multi-cycle operation performed over a plurality of instruction cycles;
the arithmetic operation for each pair of operands is performed in a different instruction cycle to the arithmetically precise summation operation;
the at least one alignment operation comprises a first alignment operation performed in a same clock cycle as the arithmetic operation and a second alignment operation performed in a same clock cycle as the arithmetically precise summation operation; and
a bit width of an output of the first alignment operation is less than a bit width of the output of the second alignment operation.
   Clause 13. The apparatus of clause 12 when dependent on clause 8, wherein:
the accumulator alignment operation is performed in a same clock cycle as accumulating the intermediate result into the accumulation source.
   Clause 14. The apparatus of any preceding clause, wherein the floating point accumulate instruction is a floating point dot product instruction, and the floating point accumulation operation is a dot product with accumulation operation.
   Clause 15. The apparatus of clause 14, wherein:
the plurality of arithmetic combination units comprises N arithmetic combination units;
the decoder circuitry is responsive to at least two types of floating point dot product instruction including an N-product floating point dot product instruction specifying N pairs of floating point operands, and an M-product floating point dot product instruction specifying M pairs of floating point operands, wherein M is less than N; and
the processing circuitry is responsive to the control signals generated in response to at least one encoding of the M-product floating point dot product instruction to perform two dot product with accumulation operations in parallel, at least one of the two dot product with accumulation operations reusing at least some of the N arithmetic combination units.
   Clause 16. The apparatus of any preceding clause, wherein the plurality of arithmetic combination units are configured to represent the plurality of arithmetic results using a twos complement representation.
   Clause 17. The apparatus of any preceding clause, wherein the processing circuitry is configured to convert a binary representation of at least one floating point operand and/or a binary representation of at least one of the arithmetic results from a first binary representation into a second binary representation whilst performing the floating point accumulation operation.
   Clause 18. The apparatus of any preceding clause, wherein the arithmetic operation comprises at least one of:
a multiplication operation; and
a division operation.
   Clause 19. The apparatus of any preceding clause, wherein the processing circuitry is configured to store at least one intermediate result of the floating point accumulation operation in a redundant binary format.
   Clause 20. A system comprising:
the apparatus of any preceding clause, implemented in at least one packaged chip;
at least one system component; and
a board,
wherein the at least one packaged chip and the at least one system component are assembled on the board.
   Clause 21. A chip-containing product comprising the system of clause 17 assembled on a further board with at least one other product component.
   Clause 22. A method comprising:
with decoder circuitry and in response to a floating point accumulate instruction identifying a plurality of pairs of floating point operands and an accumulation source generating control signals to trigger a floating point accumulation operation; and
with processing circuitry and in response to the control signals, performing the floating point accumulation operation, comprising:
   for each pair of operands of the plurality of pairs of floating point operands, performing an arithmetic operation to combine that pair of operands;
   receiving arithmetic results generated by each of the plurality of arithmetic combination units and performing an arithmetically precise summation operation to calculate an intermediate result by summing the arithmetic results, wherein the intermediate result is independent of an order in which the arithmetic results are summed;
   retrieving a prior accumulation value from the accumulation source and accumulating the intermediate result into the accumulation source; and
   performing a rounding operation after accumulating the intermediate result into the accumulation source; and
   with the processing circuitry propagating additional precision information to the rounding operation, the additional precision information relating to at least one of the arithmetic results, the intermediate result, or the prior accumulation value.
      Clause 23. A non-transitory computer-readable medium to store computer-readable code for fabrication of the apparatus of any of clauses 1 to 21.

We claim:

1. An apparatus comprising:
decoder circuitry responsive to a floating point accumulate instruction identifying a plurality of pairs of floating point operands and an accumulation source, to generate control signals to trigger a floating point accumulation operation; and
processing circuitry responsive to the control signals, to perform the floating point accumulation operation, the processing circuitry comprising:
a plurality of arithmetic combination units configured, for each pair of operands of the plurality of pairs of floating point operands, to perform an arithmetic operation to combine that pair of operands;
summation circuitry configured to receive arithmetic results generated by each of the plurality of arithmetic combination units and to perform an arithmetically precise summation operation to calculate an intermediate result by summing the arithmetic results, wherein the intermediate result is independent of an order in which the arithmetic results are summed;
accumulation circuitry configured to retrieve a prior accumulation value from the accumulation source and to accumulate the intermediate result into the accumulation source; and
rounding circuitry configured to perform a rounding operation after accumulating the intermediate result into the accumulation source,
wherein the processing circuitry is configured to propagate additional precision information to the rounding circuitry, the additional precision information relating to at least one of the arithmetic results, the intermediate result, or the prior accumulation value.

2. The apparatus of claim 1, wherein the processing circuitry is configured to defer rounding of results of the arithmetic operation for each pair of operands until the rounding operation, and to defer rounding of results of the arithmetically precise summation operation until the rounding operation.

3. The apparatus of claim 1, wherein:
the processing circuitry is configured to support at least one floating point format specifying at least a significand portion having a significand bit width and an exponent portion having an exponent bit width; and
the additional precision information comprises additional significand information extending a bit width of at least one of the arithmetic results by at least one additional bit relative to a bit width of the significand portion of the plurality of pairs of floating point operands.

4. The apparatus of claim 3, wherein the bit width of the significand portion of each of the arithmetic results is greater than or equal to a sum of the bit width of the significand portions of each of the pair of operands from which that arithmetic result is generated.

5. The apparatus of claim 3, wherein the processing circuitry comprises alignment circuitry to perform at least one alignment operation to align the arithmetic results to a common magnitude prior to the arithmetically precise summation operation.

6. The apparatus of claim 5, wherein the common magnitude is determined based on at least one of:
a magnitude of a largest exponent of the arithmetic results; and
a summation of a maximum calculable arithmetic exponent and a characteristic multiplicity factor determined as a ceiling value of a base-2 logarithm of a multiplicity of the plurality of pairs of floating point operands.

7. The apparatus of claim 6, wherein the summation circuitry is configured to output the intermediate result having an intermediate result bit width extended to comprise:
a most significant portion comprising sufficient bit width to store the significand portion of the prior accumulation value; and
a least significant portion having a bit width sufficient to store the intermediate result.

8. The apparatus of claim 7, wherein the accumulation circuitry comprises accumulator alignment circuitry to perform an accumulator alignment operation to align the significand portion of the prior accumulation value to the common magnitude based on a magnitude stored in the exponent portion of the prior accumulation value and the common magnitude.

9. The apparatus of claim 8, wherein when the magnitude stored in the exponent portion of the prior accumulation value exceeds the common magnitude by an amount greater than a bit width of the most significant portion, the accumulator alignment operation comprises aligning the significand portion of the prior accumulation value to the most significant portion.

10. The apparatus of claim 8, wherein the accumulator alignment circuitry is configured:
to shift the significand portion of the prior accumulation value by a shift amount equal to a difference between the magnitude of the exponent portion of the prior accumulation value and the common magnitude;
when the shift amount indicates a shift in a first direction, to shift the significand of the prior accumulation value in the first direction by the shift amount; and
when the shift amount indicates a shift in a second direction opposite to the first direction, to shift the significand portion of the prior accumulation value in the first direction by an amount equal to a difference between a predetermined correction amount and the shift amount and to shift the significand portion of the prior accumulation value by the predetermined correction amount in the second direction.

11. The apparatus of claim 3, wherein:
the accumulation circuitry is configured to output an unrounded result obtained by accumulating the intermediate result into the accumulation source; and
the apparatus comprises normalising circuitry configured, prior to the rounding operation, to normalise the unrounded result.

12. The apparatus of claim 3, wherein:
the processing circuitry comprises alignment circuitry to perform at least one alignment operation to align the arithmetic results to a common magnitude prior to the arithmetically precise summation operation;
the floating point accumulation operation is a multi-cycle operation performed over a plurality of instruction cycles;
the arithmetic operation for each pair of operands is performed in a different instruction cycle to the arithmetically precise summation operation;
the at least one alignment operation comprises a first alignment operation performed in a same clock cycle as the arithmetic operation and a second alignment operation performed in a same clock cycle as the arithmetically precise summation operation; and
a bit width of an output of the first alignment operation is less than a bit width of the output of the second alignment operation.

13. The apparatus of claim 12, wherein:
the accumulation circuitry comprises accumulator alignment circuitry to perform an accumulator alignment operation to align the significand portion of the prior accumulation value to the common magnitude based on a magnitude stored in the exponent portion of the prior accumulation value and the common magnitude; and
the accumulator alignment operation is performed in a same clock cycle as accumulating the intermediate result into the accumulation source.

14. The apparatus of claim 1, wherein the floating point accumulate instruction is a floating point dot product instruction, and the floating point accumulation operation is a dot product with accumulation operation.

15. The apparatus of claim 14, wherein:
the plurality of arithmetic combination units comprises N arithmetic combination units;
the decoder circuitry is responsive to at least two types of floating point dot product instruction including an N-product floating point dot product instruction specifying N pairs of floating point operands, and an M-product floating point dot product instruction specifying M pairs of floating point operands, wherein M is less than N; and
the processing circuitry is responsive to the control signals generated in response to at least one encoding of the M-product floating point dot product instruction to perform two dot product with accumulation operations in parallel, at least one of the two dot product with accumulation operations reusing at least some of the N arithmetic combination units.

16. The apparatus of claim 1, wherein the plurality of arithmetic combination units are configured to represent the plurality of arithmetic results using a twos complement representation.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17 assembled on a further board with at least one other product component.

19. A method comprising:
with decoder circuitry and in response to a floating point accumulate instruction identifying a plurality of pairs of floating point operands and an accumulation source generating control signals to trigger a floating point accumulation operation; and
with processing circuitry and in response to the control signals, performing the floating point accumulation operation, comprising:
for each pair of operands of the plurality of pairs of floating point operands, performing an arithmetic operation to combine that pair of operands;
receiving arithmetic results generated by each of the plurality of arithmetic combination units and performing an arithmetically precise summation operation to calculate an intermediate result by summing the arithmetic results, wherein the intermediate result is independent of an order in which the arithmetic results are summed;
retrieving a prior accumulation value from the accumulation source and accumulating the intermediate result into the accumulation source; and
performing a rounding operation after accumulating the intermediate result into the accumulation source; and
with the processing circuitry propagating additional precision information to the rounding operation, the additional precision information relating to at least one of the arithmetic results, the intermediate result, or the prior accumulation value.

20. A non-transitory computer-readable medium to store computer-readable code for fabrication of an apparatus comprising:
decoder circuitry responsive to a floating point accumulate instruction identifying a plurality of pairs of floating point operands and an accumulation source, to generate control signals to trigger a floating point accumulation operation; and
processing circuitry responsive to the control signals, to perform the floating point accumulation operation, the processing circuitry comprising:
a plurality of arithmetic combination units configured, for each pair of operands of the plurality of pairs of floating point operands, to perform an arithmetic operation to combine that pair of operands;
summation circuitry configured to receive arithmetic results generated by each of the plurality of arithmetic combination units and to perform an arithmetically precise summation operation to calculate an intermediate result by summing the arithmetic results, wherein the intermediate result is independent of an order in which the arithmetic results are summed;
accumulation circuitry configured to retrieve a prior accumulation value from the accumulation source and to accumulate the intermediate result into the accumulation source; and
rounding circuitry configured to perform a rounding operation after accumulating the intermediate result into the accumulation source,
wherein the processing circuitry is configured to propagate additional precision information to the rounding circuitry, the additional precision information relating to at least one of the arithmetic results, the intermediate result, or the prior accumulation value.
